(19) United States
(12) Patent Application Publication
(10) Pub. No.: US 2007/0128939 A1
(43) Pub. Date: Jun. 7, 2007

(54) Stackable Cable Hanger

(75) Inventors: David Low, New Lenox, IL (US); Raymond Horvath, Tinley Park, IL (US); Albert Cox, Orland Park, IL (US); Eric Nofziger, Schaumburg, IL (US); Richard Korczak, Channahon, IL (US)

Correspondence Address: BABCOCK IP, PLLC, P.O.BOX 488, 4934 WILDWOOD DRIVE, BRIDGMAN, MI, 49106, US

(73) Assignee: Andrew Corporation, Westchester, IL (US)

(21) Appl. No.: 11/618,124

(22) Filed: Dec. 29, 2006

Related U.S. Application Data
(63) Continuation-in-part of application No. 10/709,489, filed on May 10, 2004, now Pat. No. 7,175,138.

(51) Int. Cl. H01R 9/03

(52) U.S. Cl. 439/610

(57) ABSTRACT

A cable hanger having shell halves adapted to mate with each other, the shell halves each having an inner surface adapted to cooperate with the other to secure the cable within a cable space. The mating of the shell halves is releasably secured by a means for closure. A bolt hole through at least one of the shell halves allows easy mounting of the cable hanger. The shell halves each having, along a vertical mating surface, a means for interlocking adapted to interlock with the means for interlocking of a second cable hanger positioned against the cable hanger along the vertical mating surface. A connection side of the cable hanger may be adapted to have a means for latching to couple with a third cable hanger, positioned connection side to connection side with the cable hanger. The cable hanger allowing additional cables to be added without modifying the mounting of the base hanger.

### CROSS REFERENCE TO RELATED APPLICATIONS

This application is a Continuation-In-Part of U.S. Utility patent application Ser. No. 10/709,489 by David Low et al, filed May 10, 2004 and hereby incorporated by reference in the entirety.

### BACKGROUND OF INVENTION

1. Field of the Invention

This invention relates generally to devices for supporting cables and, in particular, to hangers for securing cables to support structures.

2. Description of Related Art

Cable hangers are commonly used to secure cables to structural members of, for example, antenna towers and or along tunnel walls. Generally, each cable is attached to a structural member by cable hangers mounted at periodically-spaced attachment points.

Antenna towers and or tunnels may be crowded due to the multiplicity of cables required for signal-carrying. Over time, as systems are added, upgraded and or expanded, installation of additional cables may be required. To conserve space, it is desirable for each set of cable hangers to secure more than a single cable. Certain cable hangers have been constructed to secure multiple cables; other cable hangers have a stackable construction that permits multiple cable hangers to be interlocked extending outwardly from each mounting point/structural member. Stacked and multiple-cable-type cable hangers significantly increase the number of cables mountable to a single attachment point.

Prior vertically stackable multiple cable capable cable hangers, for example as disclosed in US Patent Application Publication US 2004/0061030 by Goodwin et al, required opening of the existing cable hanger to insert an additional cable into an unused cable holding space of the cable hanger. The prior cable hanger incorporated mounting hardware comprising a threaded rod that extended through each additional cable hanger in the vertical stack. Besides a significant materials expense, extending the cable hangers into stacked configurations requires initial installation of longer threaded rod than necessary and or exchange of mounting hardware that momentarily removes support for the existing cables, increasing installation complexity and costs.

The various single and multiple cable hangers of different capacities necessitate manufacturing, distribution and storage costs for a family of different hangers and similarly a range of different mounting hardware of varying lengths for each anticipated hanger stack configuration. Competition within the cable hanger market has focused attention on ease of use, reliability, expandability and overall reductions in manufacturing, distribution and installation costs.

Therefore, it is an object of the invention to provide a device that overcomes deficiencies in the prior art.

### BRIEF DESCRIPTION OF DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a top perspective view of a cable hanger in accordance with the principles of the invention.

FIG. 2 is a bottom perspective view similar to FIG. 1.

FIG. 3 is perspective view of the cable hanger of FIG. 1, in which the shell halves are folded to a closed position.

FIG. 4 is a perspective view similar to FIG. 3, showing the cable hanger closed around a cable and secured with typical mounting hardware.

FIG. 5 is a perspective view of a plurality of the cable hangers of FIG. 3 in a stacked configuration closed around representative cables.

FIG. 6 is a perspective view of a plurality of cable hangers as shown in FIG. 5, also with a side stack of hangers attached.

FIG. 7 is a perspective top view of a front shell half according to a second exemplary embodiment of the invention.

FIG. 8 is a perspective bottom view of a front shell half according to a second exemplary embodiment of the invention.

FIG. 9 is a perspective top view of a rear shell half according to a second exemplary embodiment of the invention.

FIG. 10 is a perspective bottom view of a rear shell half according to a second exemplary embodiment of the invention.

FIG. 11 is an end view of a front shell half according to a second exemplary embodiment of the invention, stacked upon a rear shell half.

FIG. 12 is a side section view of a front shell half according to a second exemplary embodiment of the invention, stacked upon a rear shell half, taken along line A-A of FIG. 11.

FIG. 13 is a top view of a front shell half according to a second exemplary embodiment of the invention, stacked upon a rear shell half.

FIG. 14 is a close-up of a locking wedge from FIG. 12.

FIG. 15 is a close-up of a locking wedge from FIG. 13.

FIG. 16 is a close-up of the second exemplary embodiment showing three stacks of end to end connected cable hangers installed around coaxial cable.

### DETAILED DESCRIPTION

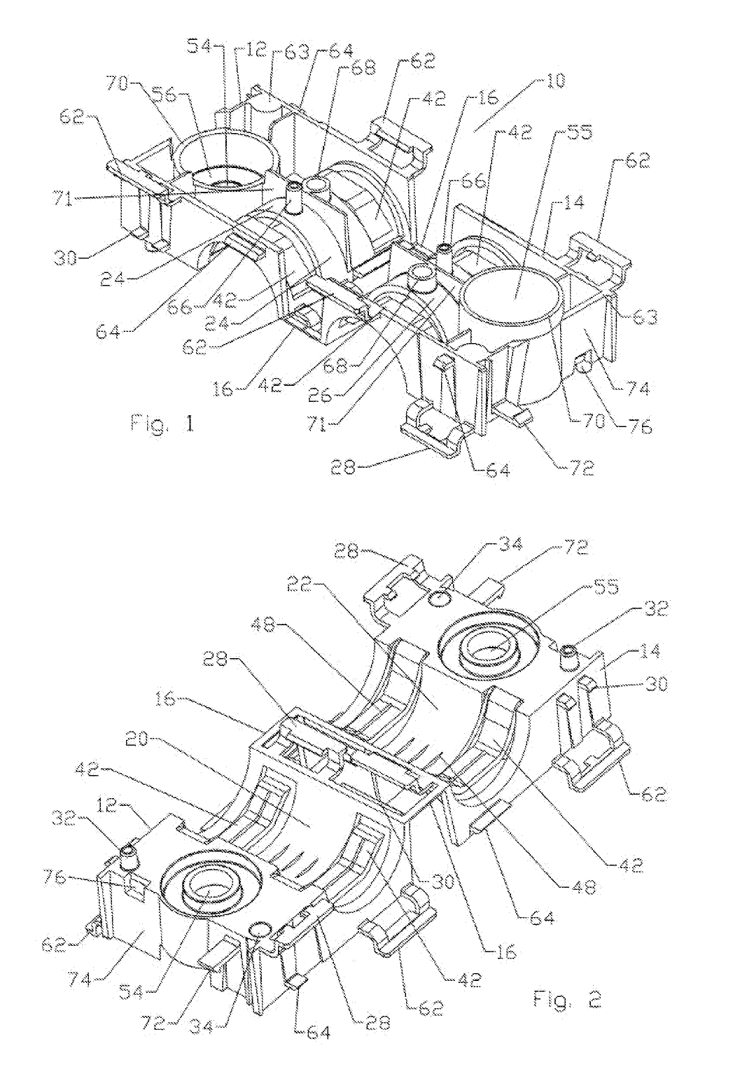

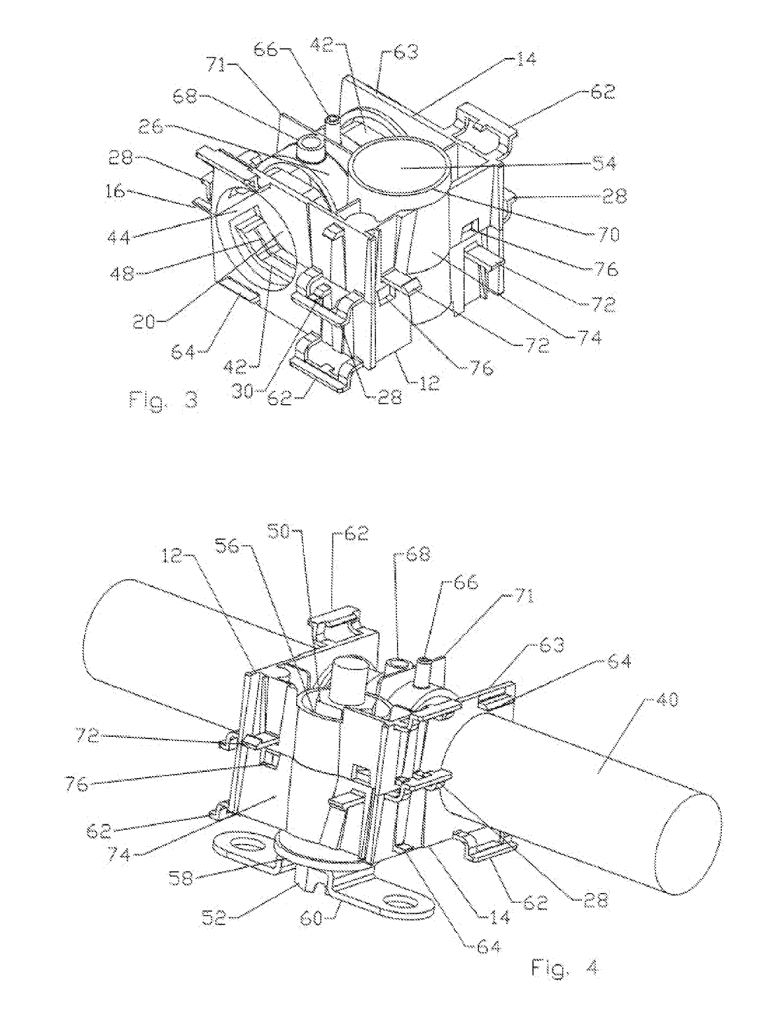

With reference to FIGS. 1 and 2, a cable hanger 10 of the invention includes a front shell half 12 and a rear shell half 14 that may be hingeably joined together by one or more spaced-apart assembly hinge(s) 16. The shell halves 12, 14 are folded or closed one onto the other to create an enclosing or encasing structure. When folded, respective front shell half inner surface 20 and rear shell half inner surface 22 of the shell halves 12, 14 have a confronting relationship and respective front shell half outer surface 24 and rear shell half outer surface 26 of the shell halves 12, 14 face away from each other in opposite directions. The assembly hinge(s) 16 may be provided for temporarily coupling the shell halves 12, 14 together for ease of manufacture and or distribution until folding for assembly and may be frangible. The relative thinness of the assembly hinge(s) 16 relative to the shell halves 12, 14 facilitates the folding of the shell halves 12, 14. Cable hanger 10 is self-locking when the shell halves 12, 14 are folded together, as shown in FIG. 3. A releasable snap-interlock means for closure is created, for example, by the interlock between a plurality of closure flange(s) 28 and closure fin(s) 30 of the front shell half 12 and or rear shell half 14 that are adapted to mate with and engage corresponding closure flange(s) 28 and closure fin(s) 30 of the respective rear shell half 14 and front shell half 12 as the two shell halves 12, 14 are engaged together. Closure alignment pin(s) 32 that fit into corresponding closure aperture(s) 34 or the like formed in the shell halves 12, 14 align the respective closure flange(s) 28 with the closure fin(s) 30 and also ensure that the shell halves 12, 14 are aligned together. Thereby, inner surfaces 20, 22 cooperate to surround and secure between them the outer diameter of a desired cable 40 within a cable space 44, as shown in FIG. 4.

The cable 40 may be further retained between the shell halves 12, 14 by a plurality of gripping finger(s) 42 extending into the cable space 44. The gripping finger(s) 42 are adapted to deflect as a cable 40 is inserted into the cable space 44 and the shell halves 12, 14 snap-interlock together, creating a bias against the cable 40 which creates a secure grip upon a desired standard cable 40 outer diameter. The gripping finger(s) 42 operate to extend a range of acceptable cable 40 outer diameter variability resulting from, for example, different production batches of cable and or different cable manufacturers. Retention of the cable 40 within the cable space 44 may be further and or alternatively enhanced by the addition of rib(s) 48 to the respective inner surfaces 20, 22 of the shell halves 12, 14 and or gripping finger(s) 46, if present. The rib(s) 48 may be, for example, spaced apart in a parallel configuration to coincide with the expected spacing of corrugations formed in an outer conductor of the cable 40.

With continued reference to FIG. 4, when snap interlocked around a cable 40, the cable hanger 10 may be coupled to a mounting surface by mounting hardware such as a nut 50 and bolt 52 or the like. Front shell half bolt hole 54 and rear shell half bolt hole 55 respectively formed in the shell halves 12, 14 align when the cable hanger 10 is folded. A recessed nut surface 56 formed in the front shell half 12 allows the bolt 52, inserted through the bolt hole(s) 54, 55 to be secured via, for example, the nut 50 without requiring a bolt 52 that extends above the top surface of the cable hanger 10.

FIGS. 4-6 demonstrate mounting hardware in the form of a ceiling adapter plate 60 with a washer 58 for securing the bolt 52 to the ceiling adapter plate 60 which is in turn mounted to the desired mounting surface. Alternative mounting configurations may include any manner of attachment wherein a bolt 52 or the like is secured to a desired mounting surface and the cable hanger 10 attached in turn to the bolt 52 or the like as described hereinabove.

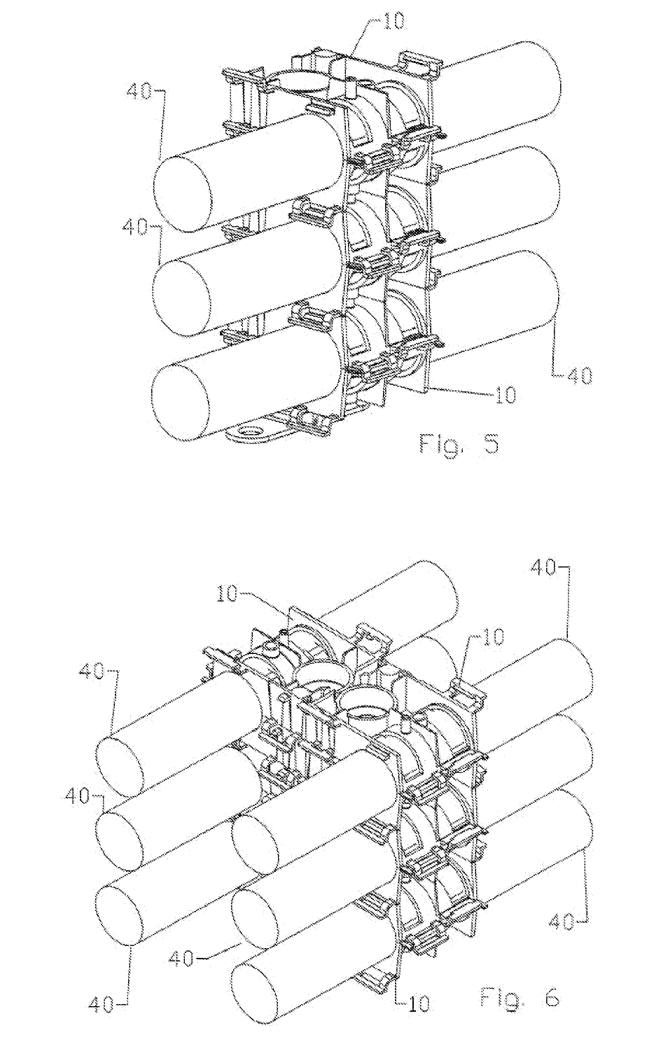

Multiple cable hanger(s) 10 may be vertically snap-interlocked together as shown in FIG. 5. A releasable snap-interlock means for interlocking between cable hanger(s) 10 is provided, for example, by the engagement between a plurality of interlock flange(s) 62 and interlock fin(s) 64 distributed around a vertical mating surface 63 of the front shell half 12 that are adapted to mate with and engage corresponding interlock flange(s) 62 and interlock fin(s) 64 distributed around the vertical mating surface 63 of the rear shell half 14 as the rear shell half 14 of a cable hanger 10 is lowered upon a front shell half 12 of a base cable hanger 10. Interlock alignment pin(s) 66 that fit into corresponding interlock aperture(s) 68 or the like formed in the shell halves 12, 14, for example projecting outward from the outer surfaces 24, 26 may be used to align the respective interlock flange(s) 62 with the interlock fin(s) 64 and also ensure that the shell halves 12, 14 are aligned together whereby the longitudinal axis of the cable space(s) 44 of each cable hanger 10 are parallel. Further alignment may be incorporated by recessing a, for example, cylindrical mounting post 70 coaxial with the bolt hole 50 on the front shell half 12 below the vertical mating surface 63 and similarly extending a corresponding mounting post 70 to project beyond the mating surface 63 of the rear shell half 14. Thereby, when vertically snap-interlocked together, the extending mounting post 70 of a rear shell half 14 mates into the recessed area of the corresponding front shell half 12 mounting post 70.

The outer surfaces 24, 26 of the cable hanger 10 may be reinforced via addition of a reinforcing fin 71 extending from the outer surfaces 24, 26 to their respective vertical mating surface(s) 63. Also, the reinforcing fin 71 may extend laterally to join the cylindrical mounting post(s) 70.

A cable hanger 10 may also be coupled with a cable hanger 10, side to side through the addition of suitable side interlocking means for latching such as at least one side latch 72 that mates with a corresponding side aperture 76 in the second cable hanger 10. As shown in FIGS. 1, 2 and 5, the side interlocking means may be formed in a connection side 74 of each cable hanger 10. To allow side to side interconnection of a unitary cable hanger 10 design, the side latch(s) 72 and side aperture(s) 76 are arrayed on the connection side 74 in complementary positions.

The various closure flange 28 to closure fin 30 and interlock flange 62 to interlock fin 64 pairs are arranged upon the cable hanger 10 clear of the connection side 74 area to allow each to be engaged and or released without interfering with a side attached cable hanger 10. Further, each of the side by side coupled cable hanger(s) 10 may be stacked vertically as described herein above to form a high density cable hanger 10 assembly, as shown for example in FIG. 6, requiring only a single attachment point to the desired support structure.

One skilled in the art will recognize that the interlock flange(s) 62, closure flange(s) 28, side latch(s) 72 and their respective mating fin(s) and or aperture(s) may alternatively be formed in numerous well known alternative configurations having an equivalent effect of securely snap-interlocking the respective components to each other. Therefore, each of the selected labels used for these elements should be recognized as functionally descriptive for clarity rather than as specific structural limitations to the type of snap-interlocking that may be applied when practicing the various embodiments of the invention. The cable hanger 10 may be cost efficiently formed by injection molding as a unitary structure from a suitable polymer resin, such as conventional thermoset or thermoplastic resins. Suitable injection molding materials include polycarobonate, polypropylene, polyoxymethylene (POM), polybutylene terephthalate (PBT) and acetal copolymer or the like. The selected polymer resin may be mixed with glass or mineral materials. Depending upon the material used and the intended application, additives such as carbon black for UV protection may be included. For underground and or tunnel applications, non-halogenated fire retardant plastics may be used. In use, a cable 40 is positioned within one of the inner surfaces 20, 22 and the shell halves 12, 14 folded towards each other along the assembly hinge(s) 16, 18 to surround the cable 40 within the cable area 44. As the shell halves 12, 14 close upon each other, spring finger(s), if present, are deflected against the cable 40, creating a bias against and thereby gripping the cable 40 securely, the various guide surfaces engage to ensure alignment between the shell halves 12, 14 and the closure flange(s) 28 and closure fin(s) 30 snap-interlock with each other. The cable hanger 10 may then be secured by mounting hardware to a desired mounting point, for example via a bolt 52 or the like which is, for example, inserted through the bolt hole(s) 54, 55 and secured with a nut 50 tightened against the recessed nut surface 56.

Once a single cable hanger 10 has been secured, additional cable hanger(s) 10 may be vertically or connection side 74 to connection side 74 snap interlocked as described herein. Because the base cable hanger 10 is secured using a single set of mounting hardware coupled only to the base cable hanger 10, further cable hanger(s) 10 may be added without disassembly or changing out of the mounting hardware. Therefore, to install a single cable hanger, a multiple cable hanger assembly, or to add additional cable 40 carrying capacity to an existing cable hanger 10 installation over time only a single type of cable hanger 10 is required. Further, only a single type of mounting hardware needs to be distributed with the cable hangers independent of the number of cable hangers that may be installed originally and over time as the number of required cables changes. Still further, installation of additional cable hanger(s) 10 to an existing installation is simplified because the existing cable hanger(s) 10 need not be released even momentarily.

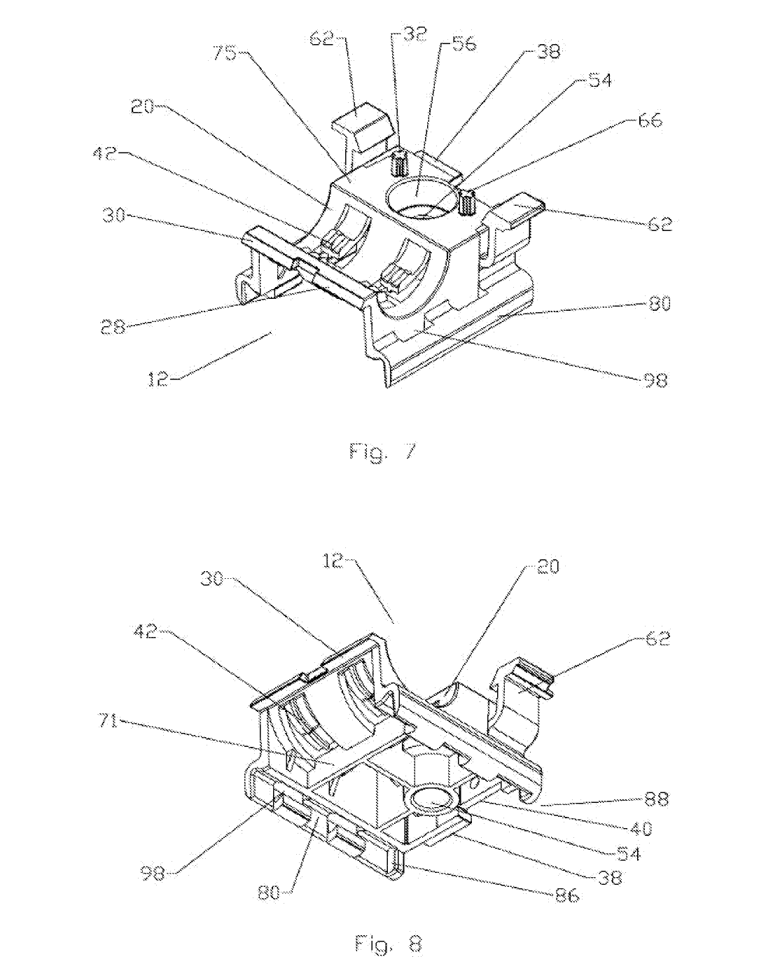

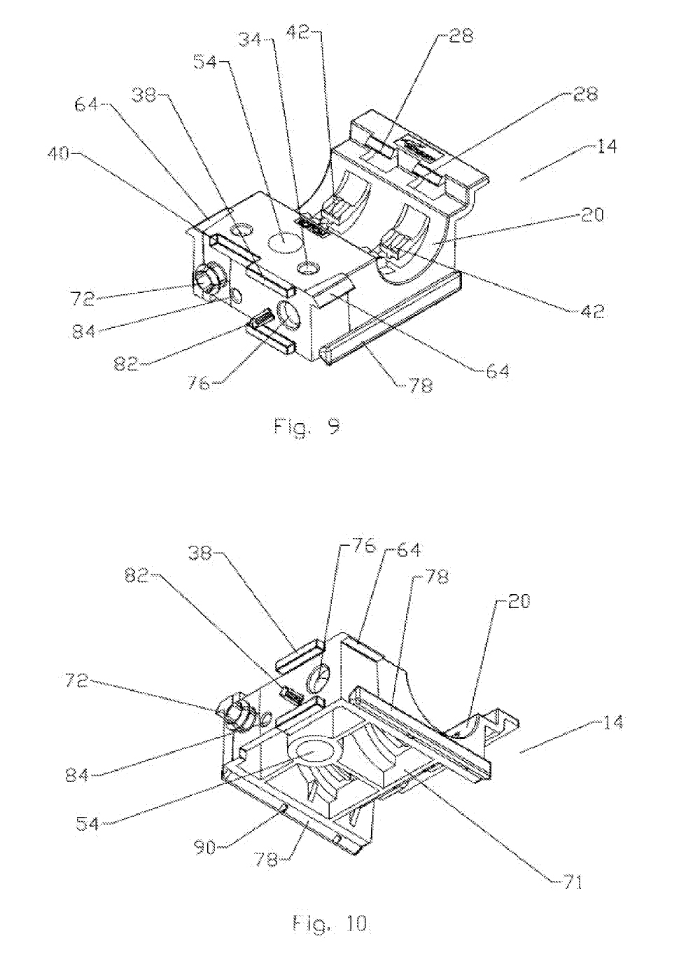

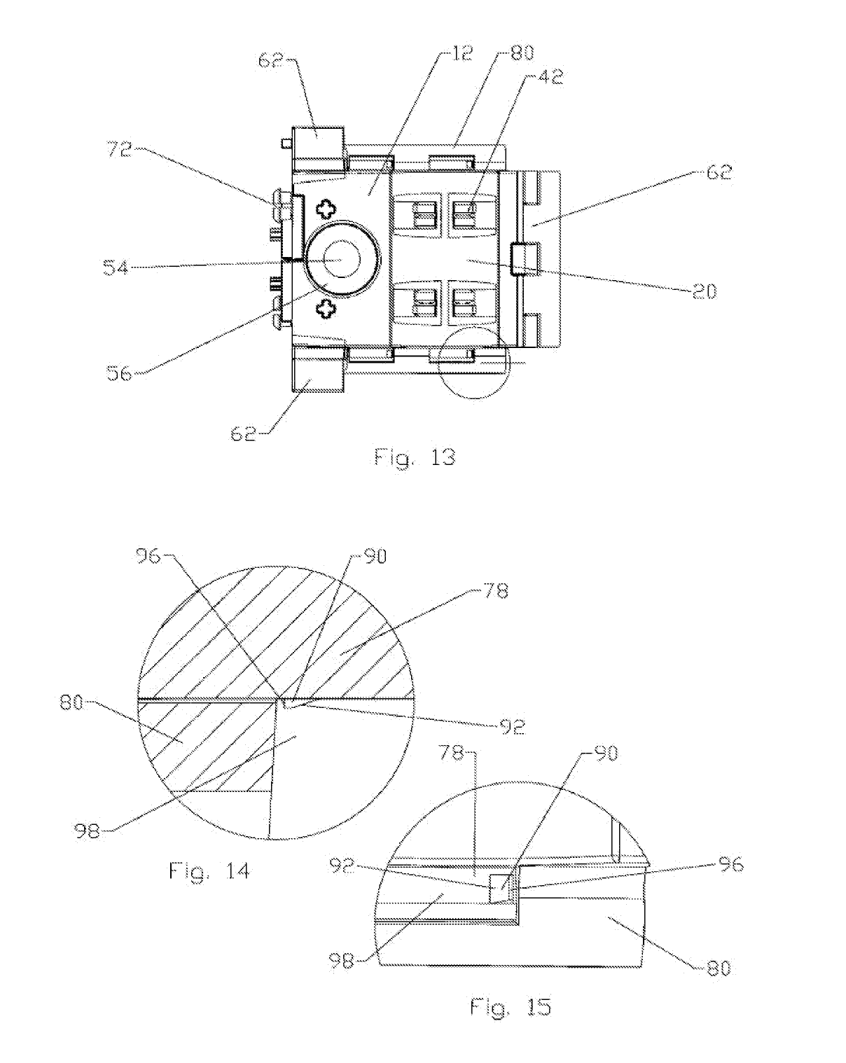

A second embodiment of the invention is shown in FIGS. 7-16, common elements having common element notations. The second embodiment demonstrates alternatives with respect to the attachment means for snap assembly around each cable and also for the stacking interlock of multiple cable hanger(s) 10 vertically and side to side. A front shell half 12, as shown in FIGS. 7 and 8, and a rear shell half 14, as shown in FIGS. 9 and 10, have a means for closure formed as complementary features to enable snap interlocking about a desired cable via a closure fin 30 of the front shell half 12 that mates with a closure flange 28 of the rear shell half 14. Upon keying the closure fin 30 into the closure flange 28, the rear shelf half 14 may be pivoted downward towards the front shell half 12 and around the cable, not shown, to engage interlock fin(s) 64 of the rear shell half 14 with interlock flange(s) 62 of the front shell half 12. As the front shell half 12 and rear shell half 14 are mated together, closure alignment pin(s) 32 of the front shell half 12 mate into closure alignment apertures 34 of the rear shell half 14.

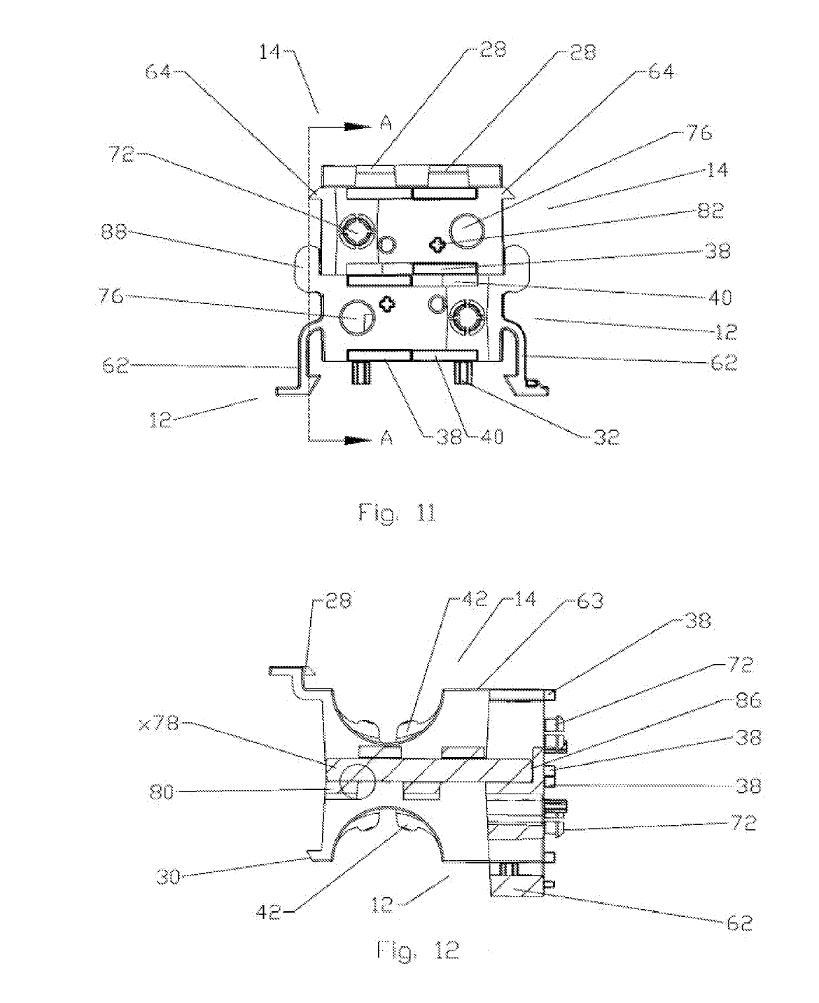

Instead of stacking additional cable hanger(s) 10 vertically via a vertical motion engaged snap attachment, the second embodiment demonstrates a means for interlocking where stacking of additional front and rear shell half 12, 14 pairs one upon another is via a key 78 into slot 80 sliding connection, for example as shown in FIGS. 11-13. The rear shell half 14 has a pair of generally parallel longitudinal key(s) 78 at the sides of the vertical mating surface 63 which slidably mate with slot(s) 80 at the sides of the vertical mating surface 63 of the front shell half 12. Alternatively, the key 78 and slot 80 may be exchanged with respect to the front and rear shell halves 12, 14 or a key 78 and slot 80 may each appear on both the front and rear shell halves 12, 14. The key 78 and slot 80 may be formed with, for example, a dovetail, rectangular or circular cross section.

Once applied, the key(s) 78 into slot(s) 80 sliding connection is retained, for example, by an end stop 86 of the slot(s) 80 at a closed end 88 and by interlocks such as locking wedge(s) 90, for example as shown in FIGS. 14 and 15, formed along the key(s) 78 that present an angled surface 92 to the mating slot 80 during insertion from the open end 94 and a locking shoulder 96 that abuts the edges of cutout(s) 98 of each slot 80 to prevent movement of the key(s) 78 backwards toward the open end (94). Further, the locking shoulder(s) 96 prevent inserting the key(s) 78 into the slot(s) 80 when the front shell half 12 is in a reversed orientation. Alternatively, the interlocks may be any form of mechanism or surface features of the key and or slot operable to allow insertion of the key(s) 78 into the slot(s) 80, but inhibit undesired removal of the key(s) 78 from the slot(s) 80 once inserted.

Cable hangers are frequently installed supporting vertical cable runs, for example up radio towers. To improve the overall strength of the stacked hanger key into slot sliding connection, the key(s) and slot(s) are preferably aligned normal to a longitudinal axis of the front and rear shell half inner mounting surface(s) 20, 26. Thereby, the load upon the key into slot interconnection is normal to the key into slot insertion direction.

Side to side hanger snap connection of the front and rear shell halves 12, 14 of the second embodiment is strengthened by a means for latching including a plurality of fin(s) 36 that mate with a corresponding plurality of shoulder(s) 38 formed in the connection side 74. Also, the means for latching uses side latch 72 and corresponding side aperture 76 pairs. The side latch 72 is demonstrated as a mushroom head formed by multiple prongs arranged in a circle. The circular mushroom head into corresponding circular aperture configuration combines ease of insertion with improved retention characteristics. An alignment pin 82 and corresponding alignment hole 84 may be applied to initially guide the two connection side(s) 74 toward one another.

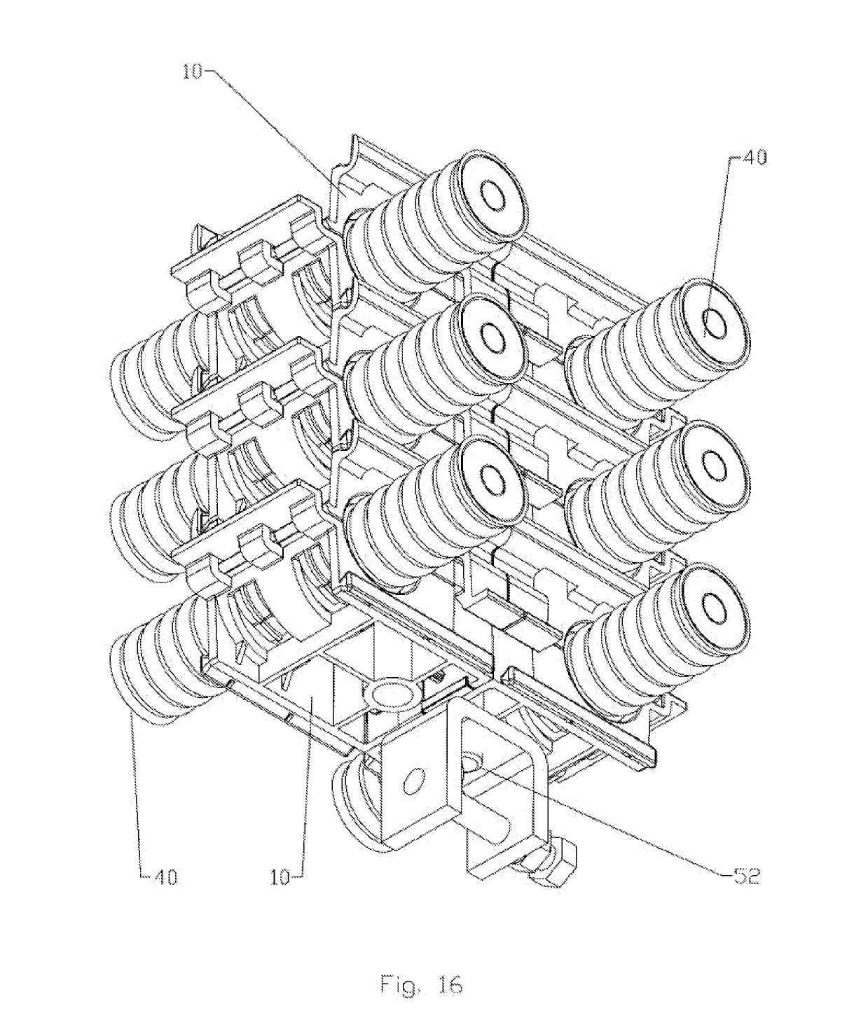

The first embodiment demonstrates a mounting bolt passing through both the front and rear shell halves 12, 14. In the second embodiment, the front shell half bolt hole 54 is configured with a recessed nut surface 56 in the top side 75, enabling connection of a cable hanger 10 stack of any desired number of cables, for example as shown in FIG. 14 to a desired mounting surface with a single bolt 52 sized to pass through only the bottom front shell half 12, saving materials costs and the overall weight of each hanger assembly. FIG. 16 demonstrates hangers retaining a total of six cables, the hangers stacked vertically and also side by side. A single bolt 52 is demonstrated as coupled to a clamp for ease of mounting to, for example, a tower support. Although the shorter bolt 52 enabled by the present embodiment may be applied, the front shell half bolt hole 54 and rear shell half bolt hole 56 align, allowing application of a bolt 52 extending through the desired number of stacked cable hanger(s) 10 for a maximum strength and or load bearing installation.

From the foregoing, it will be apparent that the present invention brings to the art an expandable cable mounting solution having improved performance, ease of installation and significant manufacturing and installation cost efficiencies.

Table of Parts

10 cable hanger
12 front shell half
14 rear shell half
16 assembly hinge
20 front shell half inner surface
22 rear shell half inner surface
24 front shell half outer surface
26 rear shell half outer surface
28 closure flange
30 closure fin
32 closure alignment pin
34 closure aperture
36 fin
38 shoulder
40 cable
42 gripping finger
44 cable space
48 rib
50 nut
52 bolt
54 front shell half bolt hole
55 rear shell half bolt hole
56 recessed nut surface
58 washer
60 ceiling adapter plate
62 interlock flange
63 vertical mating surface
64 interlock fin
66 interlock alignment pin
68 interlock alignment aperture
70 mounting post
71 reinforcing fin
72 side latch
74 connection side
75 top side
76 side aperture
78 key
80 slot
82 alignment pin
84 alignment hole
86 end stop
88 closed end
90 locking wedge
92 angled surface
94 open end
96 locking shoulder
98 cutout

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A cable hanger for mounting a cable having an outer diameter to a support structure, comprising:
a front shell half connectable with a rear shell half, the front shell half and the rear shell half each having an inner surface that cooperates with the other to secure the outer diameter of the cable within a cable space having a longitudinal axis;
the front shell half and the rear shell half releasably secured by at least one closure fin retained by at least one closure flange;
the cable hanger matable with a second cable hanger, along a top surface of the rear shell half and a bottom surface of the front shell half, via a key into slot connection slidable in a direction parallel to the top surface and the bottom surface.

2. The cable hanger of claim 1, further including a front shell half bolt hole through the front shell half; and
a recessed nut surface coaxial with the front shell half bolt hole formed in a top side of the front shell half.

3. The cable hanger of claim 1, further including a connection side of the cable hanger having at least one side latch and at least one side aperture;
the side latch and side aperture connectable with the side latch and the side aperture of a third cable hanger, positioned connection side to connection side with the cable hanger.

4. The cable hanger of claim 3, wherein the side latch is a mushroom head.

5. The cable hanger of claim 1, further including an end stop at a closed end of the slot.

6. The cable hanger of claim 1, further including a locking wedge on the key, the locking wedge having an angled surface facing the closed end of the slot.

7. The cable hanger of claim 6, wherein the slot has at least one cutout positioned to engage a locking shoulder of the locking wedge upon insertion of the key into the slot.

8. The cable hanger of claim 1, wherein the direction is normal to the longitudinal axis.

9. The cable hanger of claim 1, further including a gripping finger extending within the cable space;
the gripping finger deflectable upon entry of the cable into the cable space.

10. The cable hanger of claim 1, further including a front shell half outer surface and a rear shell half outer surface opposite the front shell half inner surface and the rear shell half inner surface, respectively;
at least one reinforcing rib extending from the front shell half outer surface to the bottom surface of the front shell half; and
at least one reinforcing rib extending from the rear shell half outer surface to the top surface of the rear shell half.

11. A cable hanger for mounting a cable having an outer diameter to a support structure, comprising:
a front shell half connectable with a rear shell half, the front shell half and the rear shell half each having an inner surface cooperating with the other to secure the outer diameter of the cable within a cable space having a longitudinal axis;
the mating of the front shell half and the rear shell half releasably secured by at least one closure fin retained by at least one closure flange;
the cable hanger connectable to a second cable hanger, along a vertical mating surface;
a front shell half bolt hole through the front shell half; and
a recessed nut surface coaxial with the front shell half bolt hole formed in a top side of the front shell half;
the cable hanger mountable to the support structure via a bolt seated against the recessed nut surface and passing through the front shell half bolt hole.

12. The cable hanger of claim 11, wherein the connection between the cable hanger and the second cable hanger is closable in a direction normal to the vertical mating surface.

13. The cable hanger of claim 11, wherein the connection between the cable hanger and the second cable hanger is closable in a direction parallel to the vertical mounting surface and normal to the longitudinal axis.

14. The hanger of claim 11, wherein a third cable hanger is connectable to a connection side of the cable hanger, connection side to connection side with the third cable hanger.

15. The cable hanger of claim 14, wherein the connection between the cable hanger and the third cable hanger is closable in a direction normal to the connection side.

16. A cable hanger for mounting a cable having an outer diameter to a support structure, comprising:
a front shell half connectable with a rear shell half, the front shell half and the rear shell half each having an inner surface that cooperates with the other to secure the outer diameter of the cable within a cable space;
the mating of the front shell half and the rear shell half releasably secured by a means for closure;
the front shell half and the rear shell half having, along a vertical mating surface, a means for interlocking to attach a second cable hanger to the cable hanger;
a connection side of the cable hanger having a means for latching adapted to couple with the means for latching of a third cable hanger, positioned connection side to connection side with the cable hanger, the means for latching connectable in a direction normal to the connection side.

17. The cable hanger of claim 16, wherein the means for interlocking is a key and slot;

18. The cable hanger of claim 16, wherein the key and slot are locked by an end stop at a closed end of the slot and a locking wedge of the key with an angled surface facing the closed end and a locking shoulder facing an open end of the slot; the locking shoulder abutting a cutout of the slot to inhibit movement of the key towards the open end.

19. The cable hanger of claim 16, wherein the key and slot have a dovetail cross section.

20. The cable hanger of claim 16, further including a front shell half bolt hole through the front shell half; and
a recessed nut surface coaxial with the front shell half bolt hole formed in a top side of the front shell half;
the cable hanger mountable to the support structure via a bolt seated against the recessed nut surface and passing through the front shell half bolt hole.
